(19) United States
(12) Patent Application Publication
(10) Pub. No.: US 2024/0125305 A1
(43) Pub. Date: Apr. 18, 2024

(54) ENERGY PRODUCTION FROM DEEP OCEAN PRESSURE

(71) Applicant: Stirling Industries LLC, Honolulu, HI (US)

(72) Inventor: Stirling T Hebenstreit, Honolulu, HI (US)

(21) Appl. No.: 18/046,334

(22) Filed: Oct. 13, 2022

(51) Int. Cl. F03G 7/04

(52) U.S. Cl. CPC F03G 7/04

(57) ABSTRACT

A water pressure energy production system includes a head tank including water at body of water pressure, a plurality of penstocks, a plurality of hydro turbines, and associated electrical power generators, one or more electrical power storage devices, a plurality of draft tubes disposed at the water exit of each hydro turbine, a plurality of positive pressure compartments (CPPP) including water from the draft tubes at an elevated pressure, a plurality of negative pressure compartments connected to the positive pressure compartments, and a plurality of secondary hydro turbines are disposed between the positive pressure compartment and negative pressure compartments, a core generator with optional intake ports for operation at 300 ft-5000 ft or greater depths operating in a closed loop process and independent of the desalination process, but may consider the CPPP.

### TECHNICAL FIELD

This disclosure relates to the production of renewable energy and the application of physics to the production of energy that can scale net zero carbon to industrial scale for all countries. This disclosure relates to systems that utilize hydro kinetic energy production from deep ocean pressure. In addition, desalination processes may be combined therein. The present invention provides for the reduction of CO2 emissions and thus addresses global warming including sea level rise.

### BACKGROUND OF THE INVENTION

The renewable energy sector is presently represented by solar panels, concentrated solar, wind farms, bio-waste, hydropower, and ground thermal heat pumps. All are sources for home and residential, and some as commercial and Industrial scale energy sources. However, their efficiency requires large areas of operation that affect wildlife habitat leading to a degradation of trust in communities and environmental groups. The more recent reinvention of Hydrogen, although this time around, placed in the containment of a Platinum fuel cell, and although considered to be a competitor of Lithium Ion, and fantastic in its derivative mineral, water, the process will require large amounts of energy to produce.

The aesthetics and degradation of land due to sensible heat exchange is most common in the solar and wind farm sectors of renewable energy. That's why closer climates are preferred. Not only for the cooling of the surrounding terrain, but from the cooling effect snow, ice, and rain, have. None of these technologies are net zero carbon and to imagine a Net Zero energy is almost impossible. What is required is a near to Net Zero Carbon energy source as is obtainable, with a long term return for the NetZero claims and benefits and then Hydropower is an excellent source of energy, but without dredges or a removal process other than natural decomposition from the organic materials from upstream sources, an fractional amounts of methane gas is released from the material at dam base. Then the River-Run and lake hydropower debates continue amongst fish and wildlife experts, native groups, and conservative minded advocates. Another drawback has been exemplified where Large hydropower dams have not only displaced people, but killed great deaths at one time. The threat arises when land masses shift, as in an earthquake. it's expensive, like all technologies are but once running a highly efficient energy source. And although there are limited reservoirs, we can make more with desalination and even pure seawater. For these reasons it still remains the core process with the most efficiency. Solar Panels are at best 25% efficient at best requiring large land areas to operate. Wind speed determines a wind-farms efficiency and ranges between 12% and 50% optimization depends on location, as does any clean energy technology. As with ours, wind can hamper birdlife migrations, cause parchment to the land from the power heat thermal reduction at the base and cable to grid. This is apparent with all power transfers. One benefit to our method sees the cooling of thermal power transfer and delivery through the water body around the technology itself, submarine cables and their back ups path. This greatly reduces the heat transmission losses across large distances of up to 50% of the electricity being line hauled for subregion station interfacing. Lastly, Nuclear power is posing a greater risk to humankind from the core itself, the reactor meltdown, spent rod storage and the challenges of reuse and reissue of elements 239 and 236. More threatening is when this technology is associated with a war zone, as is being seen in the Ukraine. When a cooling turbine has no primary core power supply, a secondary power, quite often diesel fuel because of its respective power ratio return, becomes the immediate back-up energy source. Chernobyl and Fukushima are prime examples of how seawater is absolutely essential to large ongoing cooling. We may not see the end of Nuclear power just yet. And the most recent best adaptation for this benefit source was seen by the building of small medium reactors (SMR's), first used in the Apollo Space Program for deep space exploration. through risks to human health from potential releases of radiation.

### SUMMARY OF THE INVENTION

The present invention provides systems and methods of hydro kinetic energy production from deep water pressure and other bodies of water. In embodiments, the hydro kinetic energy production utilizes hydro turbines which produce electrical power from pressurized water flow caused by deep ocean water pressure or from the depth of any body water. The system can be configured for applications in both closed loop or open cycled processes.

For example, an electrical energy production system of the disclosure may include a head tank on a platform barge, or ship, to include water from a body of water taken in by hoses or other fillable devices as in bladders, before entering the head tank. from a body of water at a Penstocks (plurality or single) provide gravitational force which is applied at the turbine before being directed to a return to sea compartment or desalination process. The generator can produce power from the penstock configurations between depths of 30-300 ft, or from a body of water's depth by positive pressure entering by a plurality of body of water intake manifolds or injectors. In the case of a body of water's positive pressure, pressurized water flow is turned from potential kinetic energy into mechanical by means of additional turbines in the same operational environment; barge, platform, ship, or a similar structure having the means to provide available draft and ballast to the penstock configurations, or draft and ballast for a positive pressure flow through intake manifolds or injectors. Either means has a return to sea compartment or desalination process. A generator along with plurality of positive pressure body of water intakes can be removed from the barge, platform or ship, leaving the Penstock configurations in the operational environment. The generator along with plurality of positive pressure body of water intakes can then be serviced, and submerged at 300 ft to 5000 ft depths in a the same or alternate body of water. The body of water may be the ocean, but is not limited to the ocean. A body of water may be made on land between 300-5000 feet, and water added by mechanical means to make further use of the positive pressure flow through intake manifolds or injectors method. The technology is well suited to the adaptation of Oil Rig structures in the offshore field, when shared to produce clean energy. The benefits include increasing the life cycle of oil platforms and their associated offshore service sectors. I.e. Supply Vessels, transportation, delivery and logistics, personnel, labor, all increasing national energy comparative advantages in clean energy.

An example energy production system is located at a depth of 3000 feet in an international water or Exclusive Economic Zone (200 nm) where water flow is open ported from the ocean by a plurality of positive pressure flow intake manifolds or injectors delivering high pressure water flow to a hydro turbine and AC/DC generator. Electrical generators produce electrical power from Horsepower motor ratings between 1 hp to 1000 hp, depending on the plurality and application; penstock or positive pressure flow through intake manifolds or injectors. In this embodiment the water can be open loop energy process and returned to the body of water, or placed in a closed loop process once internalized in piped flow. When at depths of 5000 ft and having a return to sea open loop energy process, the embodiment does not necessarily embody desalination. The desalination component is best used at depths between 30 ft and 300 ft in the enclosed penstock operational environment, under hourly supervision. The enclosed penstock operational environment has access from the surface and the working pressure is controlled for operational personnel safety reasons.

In embodiments, there may be a plurality of penstocks or intakes feeding a plurality of hydro turbine generators. For example, the number of penstocks may range from one to 50, but can be greater than 50. Any number of turbine generators may be connected in sequence along the penstocks length turning mechanical turbine power into electrical AC power for distribution, or as DC energy storage

In embodiments, the water exiting the turbine generators may be sent to a desalination process area. The desalination process may utilize reverse osmosis or other efficient processing means, to desalinate seawater. The desalinated water may then be directed to water bladders, or directly to a pipe for shoreside access. These methods each carry desalinated water to arid regions where they can be used for agriculture, human consumption or the Closed and Open Loop Land based energy production. A deep bored hole when filled with water provides an inland environment where the embodiment described in can exist.

Desalinated freshwater is carried in water bladders for transport. In other embodiments, water exiting the turbines may be delivered directly back to the body of water.

The disclosed platform, barge or ship energy production system may also include a compartmentalized pressure processing system. The compartmentalized pressure processing system may receive water from a turbine generator through a turbine draft tube. The draft tube increases the pressure of the water exiting the turbine generator. The high-pressure water from the draft tube is then fed into a plurality of compartments at positive-pressure which are connected to compartments which are at lower or negative pressure. The water can then pass through a turbine from the positive pressure compartment to the negative pressure compartment. In embodiments, the water flows to the deepest part of the positive pressure compartment which includes a turbine and then into the negative pressure compartment. The water can then be returned to the body of water or sent to desalination processing.

### BRIEF DESCRIPTION OF DRAWINGS

FIG. 1 shows an embodiment of an ocean pressure generator of the disclosure.

FIG. 2 shows another embodiment of an ocean pressure generator of the disclosure.

FIG. 3 shows another embodiment of an ocean pressure generator of the disclosure including compartmentalized pressure processing.

FIG. 4 shows another embodiment of an ocean pressure energy generator of the disclosure.

### DETAILED DESCRIPTION OF THE INVENTION

The disclosed systems are adaptable to the present business models used by the oil industry, and in this way can be applied universally, as an adaptable technology for oil platforms being decommissioned. Shared Technology for comparative/competitive advantages in the energy sector progress a net-zero smart-grid through its universal application. National oil and gas reserves can be further quantified when the technology is allowed to service the national electrical grid demand from building sector of 70%.

The technology can provide more long-term energy security for petroleum based transportation sector. The technology recognizes foreign partnerships and intergovernmental approaches to combatting climate change from a net-zero technology and science based implementation of necessary infrastructure and adaptation. The built technology recognizes both short-term and long term reasonable timelines for success in combatting climate change that increase our chances in combatting climate change. A well considered key factor for success is Carbon Reduction from the global electric grid. By example, Europe consumes 1000 terawatts of energy through their winter months. The present invention's technology when transferred supports a net zero smart grid supply chain model for improved economics. It does this by clean renewable energy supply that is not tied to the supply and demand of fossil fuel energy. There are also social macroeconomic, environmental benefits and conservation considerations to be further realized through combatting climate change reduces the cost impacts negatively generated from climate change global impact.

The invention stabilizes national oil reserves reduces external and internal risk factors for reliance on fossil fuels by: 1) reducing need for mined coal, 2) avoids cost of transportation, 3) avoids long term fossil fuel energy purchasing agreements, 4) negates reliance for foreign exchange trading, and 5) reduces environmental concerns. The invention lowers the threat of economic disruptions at local economic level and competes with energy markets like Hawaii, with residential electric costs of US $0.39/kWh in 2021. Hawaii and Small Island Developing States (SIDS) have high costs for energy due to their dependency on foreign oil imports and the aggressive strategies that dictate purchasing agreements from around the world. This in turn increases emissions and lowers energy consumption per capita; Hawaii is 6500 kwh/yr. per household.

The present invention may be used to recharge Energy Storage devices. The energy source is as near to net zero as is fundamentally possible by way of the source. The technology can be applied to host a territorial workforce utilizing semi-autonomous skilled and unskilled labor from a wide variety of human backgrounds. In this way an entire daily operation can be, Provide any number of able or disabled persons with an ability to operate from A territorial location anywhere in the world. In this way, energy management and climate change response task-force networking becomes more attuned to the real dynamics of people and their capabilities. Semi-Autonomous refers to Ray Jarvis, the inventor of Semi-Autonomous.

In addition, desalinated seawater can be transported to arid, dry, and drought-stricken regions of the world, where clean, potable drinking water, (United Nations—49 liters per person per day) can be mineralized and consumed. Agriculture also requires large amounts of unmineralized desalinated water for food crops. Inland lakes can benefit the water cycle, rivers, and have a cooling effect on regions where temperatures cause drought. The present invention is a design useful process incorporating available technology. It's nature, however, is to operate in a net-zero environmental dynamic principle. Water pressure at various water depths incorporates existing desalination technology or can operate completely independently.

Herein is disclosed a series of systems and technologies that form the best risk-analysis based on physics, and residential electrical grid consumption. The energy is delivered as power in units of terawatt hours, megawatt hours, and kilowatt hours. By comparison, the systems described herein, will present data comparable with State and federal source energy, and further disclosing by numerical figures, a significant advantage in global carbon emission energy reduction as seen through the US eGRID program.

The technology is DeepTek™, a submerged energy production system described herein which provides net-zero renewable energy production into utility-scale power. Low, Medium and High AC/DC voltage interconnections service conductor raceways of appropriate high amp currents from either the deep ocean pressure supply, or Penstocks, described herein, by intake ports and raceways for turbine or series of turbines, which are in a negative compartment and can be removed from the 30 ft to 300 ft structures environment, to independently operate at the 300 ft to 5000 ft depth in a closed loop or open loop process. This includes the return of water to the body to the body of water and desalination into any size that suits the 30 ft-300 ft operating environment, or as a separate HSGCube at a depth between 300 ft and 5000 ft or more, in the closed loop high pressure intake voided compartment, the HSGCube. In this embodiment, the water can enter by positive volumetric pressure and leave the same void by a second compartment's negative pressure. This is referred to as Compartmentalized Pressure Power Processing (CPPP). The system allows for a volume of water within the internal structure to be returned to a body of water at both 30 ft to 300 ft, and 300 ft to 5000 ft or greater, or be directed to a desalination process in the 30 ft to 300 ft application of the HSGCube.

The systems herein by example uses a 150 ft intake internal structure combined penstock for additional static pressure and returns specific amounts of water to a body of water on which a vessel occupies and operates. The invention presents an internal return-to-sea compartmental volume of 450 cu ft and requires a return-to-sea pressure that exceeds 64.95 psi (Penstock #1 length is 150 ft cu ft but could be more or less depending on depth and pressure of body of water. The vessel has a height from Keel Bottom to Penstock #1 (the Primary Upper Intake) of about 160 ft and so requires a return-to-sea compartmental pressure of 68.7 psi at 160 ft depth of water. From a 1,122 gallon flow rate, or 11.04 times per hour cycle, the 12,400 gallon per hour rate is obtained. This could be more or less, depending on the volume of static head, volume of head tank, flow rate and size of turbine generator (motor), minus friction losses.

The return-to-sea element at 164 ft is 450.8 cu ft compartment volume and can be 3,366 gallons every 16 m45 s. The return-to-sea element is continuous. The return-to-sea compartment volume is dependent on depth of the body of water pressure. This disclosure presents 22 high to low pressure compartments for reverse osmosis desalination and kinetic to mechanical turbine power generation. The return-to-sea element can be included or not. Reduction Gears may be used with the turbine configurations and combinations of AC or DC motors. Continuous RPM combine DC energy storage battery banks and or AC utility scale electrical service supply.

DeepTek Systems Deep Ocean Pressure (DOP) can recharge DC energy storage (ES) battery banks from anywhere they operate. ES is then deliverable to off grid disaster relief zones, used for stand-by power during outages. DOP ES can be implemented in the electric vehicle sector for charging stations to reduce CO2 emissions from power station energy source.

Provide renewable energy capacity in all SIDS (Small Island Developing States). SIDS represented around 5.3 GW at the end of 2019, of which 665 MW was installed in the last year, representing a 14.4% increase, double the global growth of 7.6%, over the same period. Small islands are at the forefront of many measures to do with climate action and are a benchmark in some measures for sustainable development.

The systems reduce power plant carbon emissions by 17,722,705,406 lbs per year (based on 2019 eGRID emissions of 2000 lbs/MWH) and enable decentralization with future regulatory and standards, achieves a Zero-Carbon Economy Transition Policy, and Futures a Climate Change Adaptation and Mitigation Technology. Promotes a Social acceptance of new grid technologies. Business models have a flexibility-merit-order and diffusion of new technologies. Futures for Regional eGRID aspects and eGRID regulatory aspects. Provides for a Multiple trading relationship performing infrastructure for electricity market. Will Include MV and LV DC standardization activities consistent with Advanced Digital Control Systems for HVDC Applications.

The invention could fall under NEMA6P; a submerged enclosure of Electrical Equipment. A body of water where depth of water dictates the First Compartments Negative Pressure Zone, and changes to a positive pressure zone when water enters the compartment from the turbine. The positive pressure zone is now in the first compartments. An adjoining low pressure compartment zone opens when limiters reach a specific volume displacing the positive pressure compartment of its water (mass). The water mass transfers from the positive pressure compartment to the negative compartment at the compartment's lowest point.

A turbine can be placed at the lowest transfer point between positive and negative compartments. This Platform, barge or ship (Vessel) can be maneuvered to relocate at other locations around the operating region, or world. When this return to void is full, the compartment releases a greater amount than the surrounding pressure outside the enclosed vessel back to the body of water. Inflatable Bladders raise desalinated seawater to the surface where it can be stored in tanks, piped ashore, or to other vessels for transport. In the case of deep ocean pressure or similarly a body of water's natural depth pressures, larger volumes of water can be returned-to-sea through open loop configurations or pumped to surface for Vessel Desalination.

The threshold for returning water to the body of water can be any amount and is relative to the positive pressure outside the Submerged Energy system, or Vessel. DeepTek System is a combined process for Deep Ocean Pressure Energy Processing combined with Compartmentalized Desalination from deep sea, near coastal, inland, lake, Great Lakes where platforms, barges, ships or decommissioned nuclear ships or similar large vessels by design, or oil rig platforms, that can operate at depths between 300 ft and 5000 ft or greater.

Onboard personnel management and energy management is operable from a floating (moored, anchored) platform, barge or ship, with similar control and monitoring systems as an oil platform. The Energy system can be configured for autonomous or semi-autonomous power management. Both the Energy system and Surface Type Platform Elements, produce AC and DC power from Kinetic Hydro Pressure Applications. The associated equipment and apparatuses make large amounts of energy for power electromagnetism transfer and direct current energy storage.

Compartmentalized Pressure Processing is a Series of Kaplan or Pelton, or other Industrial Designed Turbines, or Squirrel Cage type, all being Hermetically Sealed Turbines producing mechanical energy (power) from Kinetic energy as water passes from the positive pressure void to the negative void.

As many Turbine Generators as there are compartments can be placed in a Parallel circuit to meet the Surface Platforms Combined AC Inverter Circuit. Combined Voltage from all Generators (Motors) when combined in either series, or parallel, produce High Voltage from 3 phase 208V, or 480V, and are sent Ashore by Subsea Marine Cable to Utility substations, or another Platform, or Barge to increase power in Series, or power can be used to Recharge Battery DC Energy Storage banks.

Rechargeable Megawatt Banks are a Novelty when produced through Net-Zero Carbon can be Used in Recharging the Electric Vehicle Market anywhere in the world. Recharging Battery Banks with as close to Net Zero as is possible, is a key takeaway from a DeepTek System process.

Adaptation and Transfer of Industrial Process can be applied to an Offshore Oil Rig Platform operating in water depths disclosed herein or, greater. DeepTek Systems promotes clean air from Renewable Energy by NetZero Emissions and no Smoke Stacks. Energy Storage (ES) Megawatt capacitance can be Re-Charged and Rotated from Platform to Local and Regional markets for Alternative Power Demand.

DeePTek Systems include a Marine Mammal Protection Zone (MMPZ). The MMPZ comprises a Net Mesh attached to a bulkhead. The MMPZ protects marine life. It surrounds the Water Intake at a distance of several meters, being held at that distance by extension arms.

When referring to The Hollow Space Generator (HSG, or Cube), we refer to both Vessel and positive pressure flow through intake manifolds or injectors that are both capable of producing Megawatt energy, metered at a Turbines Generator which is defined by the Formula: 140 PSI×GPM/1714=HP×745.3 watts. From 7.48 gallons per cubic feet (0.125 gal/sec). and a single side of 1 Cubic Foot (A single side is 144 sq inches), the total combined Pressure of 140 psi is quantified 144 times by 140 psi per 144 sq inches. This is achieved by 144 Multiport Intake Injectors spaced over the 1 square foot Area. Each 140 psi injector delivers 7.48 gal/min (0.125 gal/sec) inside a body of water depth of 97.22 m. The applied formula produces 0.611 hp (1 hp=745.3 watts), or 455.35 watts per minute per Square Inch. or 27.32 KW per hour per square inch, equivalent to 239.33 Megawatts per year (239,334,492.93 watts per year). This energy amount would supply 22.34 Residential Homes with 10,715 KWH annually (the US National Annual Residential Energy Use Average—2020), per square inch at 140 psi. Alternatively when metered at a continuous rate per second, 455.64 watts per second with a flow rate of 7.48 gal/sec, achieves 14,360.1 MWH per yr., per square inch. 1.639 MW per hour, for a 28,720,139.15 lbs Reduction in Carbon Emissions. (based on an 2019 eGRID data of 2000 lbs per MWH)

Hollow Space Generator—(HSG) Compartmentalized Pressure Processing (CPP) —HSG Contains Any Combination of Hermetically Sealed AC/DC Motors, Kaplan Turbines Generators, Hermetically Sealed Squirrel Cage Fan Induction Motors Configured for High Speed Revolutions Per Minute, for the same Combination of Parallel Intakes to provide potential kinetic energy from all Intakes. Energy Flow is measured in Pounds per Square (PSI) Inch, and or Foot Pounds (ft. Lbs) at the associated working depths.

DeepTek Systems can be configured for Electrical 3-phase or Single Phase Circuits wired in Parallel for a Series Configuration at the 208V or Greater three Pole Cable Service. The HSG system delivers AC or DC power through a Submerged Marine Cable to a Shoreside Substation, or Vertically through Insulated Conductor Raceway(s) containing AWG Copper or Aluminum Conductors, Supplying the Electrical Source to a Barge, Platform, or other Floating Structure that Short-Feeds Electric Energy Directly to Utility Scale, or Recharges the Capacitance of an Energy Storage Device.

A 200 ft Barge, ship, or floating Platform (Vessel) on a body of water provides open external intakes (ports) that provide continuous Gravitational Potential Kinetic Energy as force, from falling Water, through 1 to 50 penstocks or more, being singular or configured to join at the penstock filaments (junctions) creating additional pressure before reaching the Turbine Generators.

A Vessel has a Head Tank Filled as a variation to the Continuous Intake from Open Sea Ports or Other Body of Water. The head tank can be maintained at 100% by the body of water supplying potential gravitational energy by external hoses floating at or near the body of waters surface, or hoses that fill floating bladders that filter and transfer potential gravitational energy as water, to the head tanks.

By example, a 200 ft. Vessel has a Head-tank and Penstock configuration which provides for Longitudinal Onboard Desalination Processing of 47 m3 per hour. The Intake Rate of 0.46 Cubic Foot/sec (3.44694 gallons per second), provides for 27.65 cubic feet per minute, or 206.82 gallons per minute. Hourly, this equates to 1659 cu ft, or 12,409 gallons per hour. Per day this equates to 39,816 cu ft per day, or 297,823.68 gallons of desalinated water per day per 47 m3 per hour desalination rate. Annually this equates to 108,705,643.2 gallons, or 14,532,840 cuft per yr., or, 906,849,216 lbs of seawater per yr. Water weighs 62.4 lbs per cubic foot depending on salinity. An offset to Sea-Level Rise is feasible when these methods are scaled regionally to support further global development in water supply from a combined power desalination technology process.

By example, 14,532,840 cuft per year displaces 906,849,216 lbs of Seawater. The seawater displacements from desalination are significant when referring to Sea Level Rise mitigation as an offset to the assumed and relevant scientific evidence that threatens low lying coastal nations, is best applied with renewable energy producing Compartmentalized Pressure Power Processing (CPPP) combined with Desalination of Seawater. A Rate and Cycle of 47 m3 per hour per 24 hours produces 272,562.6187944 gallons of freshwater from seawater and 910.97 lbs of salt per day. By combining 47 m3 systems, this disclosure claims rates of up to 10,000,000 ft3, which would take 271 days, but by a 1500 m3 per hour desalination system combined with a CPPP, the cycle is 7.3 days. This represents a significant offset rate to Greenland melt. Decommissioned Aircraft Carrier type vessels are capable of large production rates and associated transport of desalinated water to anywhere it is needed.

DeepTek Platform combine renewable energy and Desalinated Water the together enhance the quality of life around the world. Expansion Bladders are Filled at or below the water surface as the Last Stage in the CPPP, then lifted to a Vessel at sea level by hauling parts or Mechanical Winches operating from a permanent onboard DC Energy Storage Capacitance Battery Bank, or a separate AC Conductor Raceway junction from the HSG Platform Power. At 140 PSI (97.22 m depth) a HSG system can operate between 12 to 144 Injectors (multiport) per square foot, either in Parallel or Series Circuit. The 12 Injector Configuration delivers 439.897 hp per second (continuous), or 327,855.5 watts per second using 3.28×110 KW Generator Motors or 12×7.33 hp per minute (12×5,463 watts per minute). A return-to sea compartment example of 0.46 cu ft. per second which requires 72 Injectors on a single square foot face, equates to 3.4 gal per second per injector, or 14688 gal per minute, or 881,280 gal per hour per 72 injectors. The Kilowatt Power Converts to 894.15 Kw per minute per 72 injectors. Eight 110 KW Motors with Nameplate Ratings of 150 hp, 3600 RPM, and 218.8 ft lbs of torque each, deliver Continuous 110 KW Power.

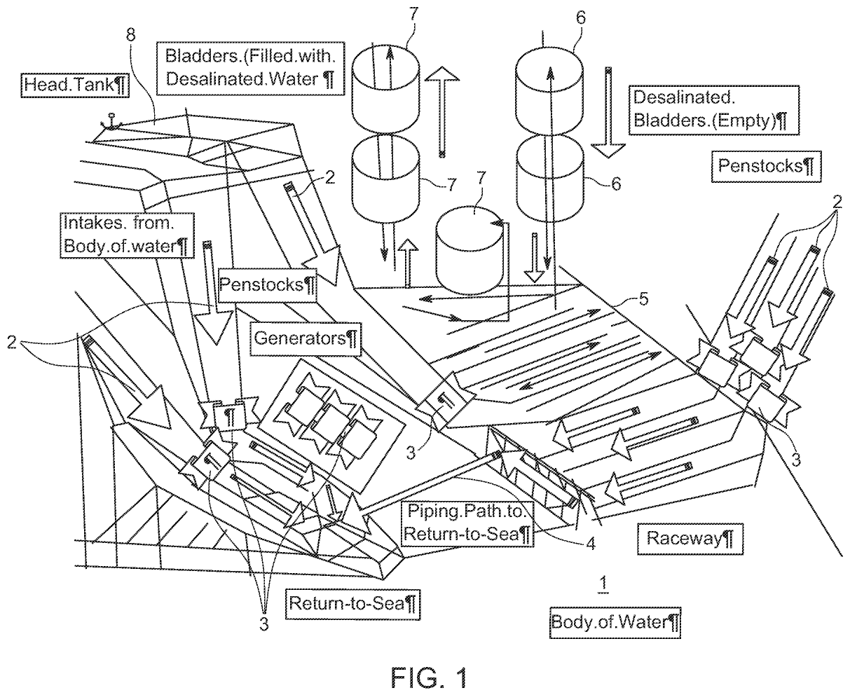

FIG. 1 shows an embodiment of an ocean pressure energy generator of the disclosure. FIG. 1 shows body of water 1, penstocks 2, turbine generators 3, piping 4 to return spent water to body of water 1, desalination area 5, desalinated bladders (empty) 6, and desalinated bladders (filled with desalinated water) 7.

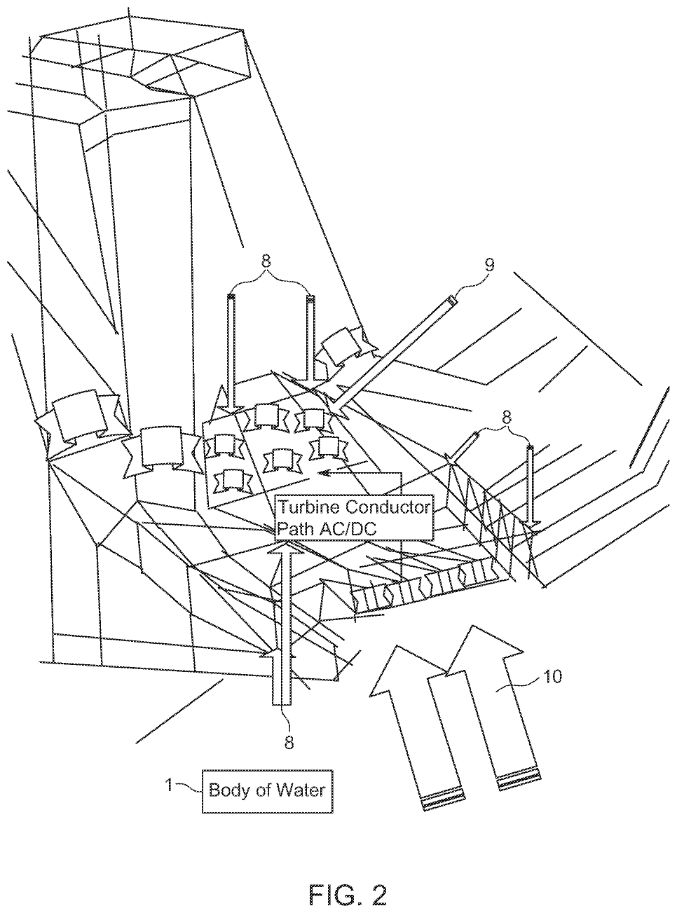

FIG. 2 shows an embodiment of an ocean pressure energy generator of the disclosure. FIG. 2 additionally shows disconnectors 8, generator/motor room 9, and intake manifold for turbines 10.

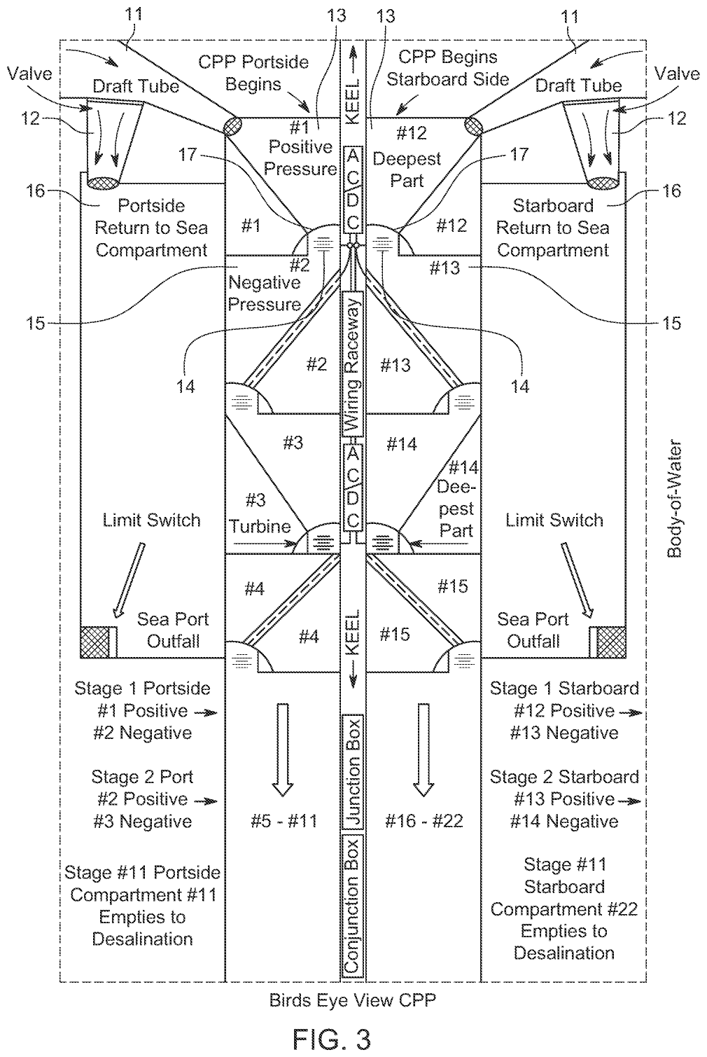

FIG. 3 shows an embodiment of compartmentalized pressure processing of the disclosure FIG. 3 shows draft tubes 11, valves 12, positive pressure compartments 13, turbine generators 14, negative pressure compartments 15, and return to body of water compartments 16, and the deepest part of the positive pressure compartments 17.

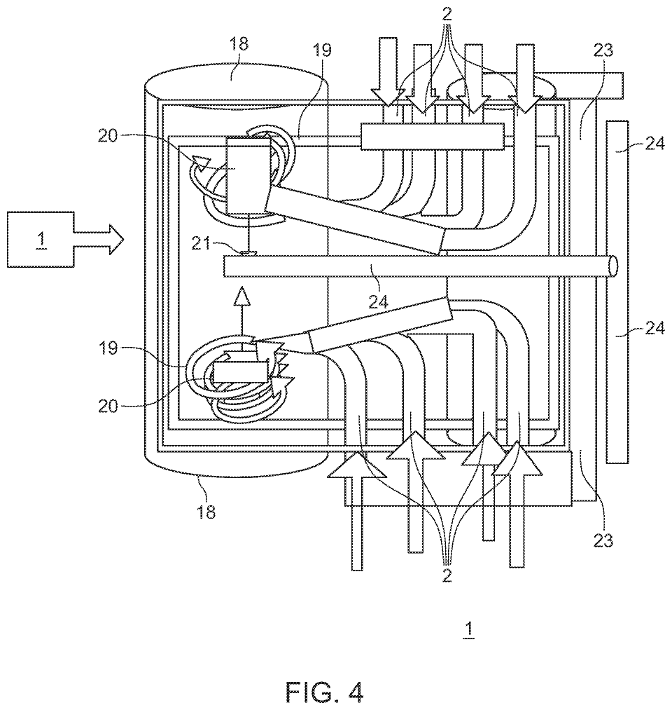

FIG. 4 shows another embodiment of an ocean pressure energy generator of the disclosure FIG. 4 shows turbines 20, generators 21, penstocks 2, open loop returns 18, closed loop pathway 19, additional head pressure 23, conductor raceway paths 24,

### Glossary

A turbine, as used herein, refers to a hydro turbine or water turbine that converts hydro kinetic energy and potential energy into mechanical work and electrical power production. See e.g., Water turbine, Wikipedia, the free encyclopedia, last edited: 12 Aug. 2022, herein incorporated by reference. Generally speaking, hydro turbines referred to herein are connected to electrical energy generators to convert the mechanical work of the turbine into electrical power. As examples, the turbines may be Francis turbines (see e.g., Francis turbine, Wikipedia, the free encyclopedia, last edited: 12 Aug. 2022, herein incorporated by reference), a Kaplan type turbine (see e.g., Kaplan turbine, Wikipedia, the free encyclopedia, last edited: 5 Sep. 2022, herein incorporated by reference), or a cross-flow or squirrel cage type turbine (see e.g., Cross-flow turbine, Wikipedia, the free encyclopedia, last edited: 27 Jul. 2021, herein incorporated by reference).

A head tank as referred to herein, refers to a water tank that holds water taken from a surrounding body of water. The water pressure in the head tank, unless otherwise specified, will be the same as the water pressure in the body of water at the depth of water that the water pressure energy production system is operating.

A penstock as used herein generally refers to a gate or intake structure that delivers water flow to a hydro turbine. See e.g., penstock, Wikipedia, the free encyclopedia, last edited: 30 Mar. 2022, herein incorporated by reference.

An electric power generator as referred to herein refers to an electrical generator that converts mechanical energy into electrical power. Generally, as referred to herein, the mechanical energy will be a result of operation of a hydro turbine. See e.g., electric generator, Wikipedia, the free encyclopedia, last edited: 30 Aug. 2022, herein incorporated by reference.

An energy storage device as referred to herein generally refers to an electric battery or a rechargeable battery. See e.g., battery, Wikipedia, the free encyclopedia, last edited: 6 Sep. 2022, herein incorporated by reference.

A draft tube as referred to here is generally a diverging tube disposed at the exit of a hydro turbine. A draft tube increases the pressure of exiting fluid from the hydro turbine. See e.g. draft tube, Wikipedia, the free encyclopedia, last edited: 24 Aug. 2022, herein incorporated by reference.

Reverse osmosis as referred to herein is a water purification process that uses a membrane to separate ions and other unwanted molecules and compounds from water. See e.g., reverse osmosis, Wikipedia, the free encyclopedia, last edited: 25 Jul. 2022, herein incorporated by reference.

Positive pressure in a positive pressure compartment generally refers to water at higher pressure than at the surface of the body of water. Negative pressure is a pressure that is less than the positive pressure in an adjacent positive pressure compartment and can be generated as a result of evacuation or partial evacuation.

Net zero as referred to herein refers to carbon neutrality which refers to net zero carbon emissions. See carbon neutral, Wikipedia, the free encyclopedia, last edited: 21 Sep. 2022, herein incorporated by reference.

### Example

At a Depth of 1000 m (3,000-3300 ft.)
1. PSI.=1400-1500 psi
2. Ft/lb.=207,000-208,000 ft lbs
3. HP/Sec.=370-400
4. HP/Minute=22,600-23,000
5. HP/Hour=1,357,000-1,500,000
6. HP/Year=11,889,000-12,000,000
7. KW/Yr=8,861,000,000,000-9,000,000,000,000
8. KW/Hour=1,000,000,000-1,100,000,000
9. Engine RPM 9.5-3000 rpm

3,000-3,300 ft depth Represents a 17,700,000,000-18,000,000,000 lbs of Carbon Emissions Reduction per system (Technology) through the HydroKinetic Energy Source.

Reduction Using the eGRID High End of 2000 lb/MWH (2019)

35,445,000,000-35,500,000.00 lbs Carbon Reduction from a 1000 lbs/MWH (Reference: Department of Energy eGRID statistic 2019).

HSG Cube System Delivers Carbon Emissions Reduction from Depth between 30-100 m.

Operations in Both EEZ and International Waters with Little or No Need for Permits

HSG takes advantage of Reclaimed Inland Arid Environments with a Bored Hole in the ground Filled with water, then pumped in a continuous fluid cycle In a Closed Loop HydroKinetic Process. This requires less, or no Large Body of Water whatsoever. Industrial Power for Producing Sector Hydrogen Fuel Cells. Industrial Power for Carbon Capture and Storage, and Splitting of Co2 into Carbon Monoxide for Material Manufacturing and Building Oxygen Reserves. The split is 386 KJ per molecule—Huge Amounts of Energy.

Industrial Power for GreenHouses, to operate at 24/7 photosynthesis carbon sequestration and Oxygen Regeneration, without the need of the sun or solar panels or energy storage. HydroPower is the most efficient renewable energy form −90% efficient. Closed Loop Systems operate on a short cycle internal path and use the same pressure received through the intake, over and over again. 800-850 kw/minute is needed to split the Carbon Oxygen mole at 700 degrees Celsius. This is essential for successful Carbon Capture Storage (CCS) and Direct Air Capture (DAC).

The system may also include a square foot face plate having 1 to 144 water ingress ports of 1 square inch each. This may be combined as 4 face plates of similar size to allow for 1 and 576 water ingress ports. They may be sized between 1 cubic foot and 1000 cubic foot. The face plates may be configured to power turbines that deliver power generation. The Turbines referred may be of the Squirrel Cage type in Parallel Series or a Francis Type Turbine.

1.-16. (canceled)

17. A water pressure energy production system configured to produce electrical power from positive water pressure produced from a body of water at a depth greater than 300 ft of the body of water comprising:
one or a plurality of head tanks each comprising water at a positive water pressure corresponding to the water depth greater than 300 ft of the body of water in fluid communication with one or a plurality of penstocks in fluid communication with one or a plurality of hydro turbines each with an associated electrical power generator that produces electrical power from the positive water pressure produced from the body of water at a depth greater than 300 ft of the body of water;
one or a plurality of electrical power storage devices; and
a compartmentalized pressure processing system that produces electrical power from the positive water pressure produced from the body of water at a depth greater than 300 ft of the body of water comprising:
one or a plurality of draft tubes disposed at a water exit of each hydro turbine;
a plurality of positive water pressure compartments in fluid communication with the draft tubes;
a plurality of negative water pressure compartments in fluid communication with the positive pressure compartments; and
a plurality of secondary hydro turbines disposed between the positive water pressure compartments and the negative water pressure compartments.

18. The water pressure energy production system of claim 17, wherein the system is configured to produce electrical energy at water depths ranging from about 1000 feet to about 5000 feet of a body of water.

19. The water pressure energy production system of claim 17, wherein the system further comprises reverse osmosis desalination.

20. The water pressure energy production system of claim 19, wherein the system further comprises water bladders for holding and transporting desalinated water.

21. The water pressure energy production system of claim 17, wherein the hydro turbine is a Francis turbine, a Kaplan turbine, or a squirrel cage turbine.

22. The water pressure energy production system of claim 17, wherein the secondary hydro turbines are disposed at the lowest region of the positive pressure compartment.

23. The water pressure energy production system of claim 17, wherein the system is configured to produce electrical energy at water depths ranging from 1000 feet to 5000 feet and is configured for closed loop pressurized internal continuous cycle operation.

24. The water pressure energy production system of claim 17, wherein the system is configured to produce electrical energy at water depths ranging from about 3000 feet to about 5000 feet and is configured for closed loop pressurized internal continuous cycle operation.

25. (canceled)
